(19) United States
(12) Patent Application Publication
(10) Pub. No.: US 2025/0132455 A1
(43) Pub. Date: Apr. 24, 2025

(54) METHODS AND APPARATUS FOR REMOVING GAS DURING THERMAL RUNAWAY IN ENERGY STORAGE SYSTEMS

(71) Applicant: Enphase Energy, Inc., Petaluma, CA (US)

(72) Inventors: Conner O’Grady FEAR, Glen Ellen, CA (US); Chien-Fan CHEN, Fremont, CA (US)

(21) Appl. No.: 18/911,935

(22) Filed: Oct. 10, 2024

Related U.S. Application Data
(60) Provisional application No. 63/544,998, filed on Oct. 20, 2023.

(51) Int. Cl. H01M 50/358; H01M 10/42; H01M 50/383

(52) U.S. Cl. CPC H01M 50/358; H01M 10/425; H01M 50/383; H01M 2010/4271

(57) ABSTRACT

An energy storage system is provided and comprises a battery enclosure comprising a battery module and configured to couple to a conduit for coupling to another battery enclosure of the energy storage system such that hot gases are allowed to expand from the battery enclosure to the another battery enclosure via the conduit, or vice versa, during thermal runaway.

### CROSS-REFERENCE TO RELATED APPLICATIONS

The present application claims the benefit of and priority to U.S. Provisional Application Ser. No. 63/544,998, filed on Oct. 20, 2023, the entire contents of which is incorporated herein by reference.

### BACKGROUND

### Field of the Disclosure

Embodiments of the present disclosure relate generally to energy storage systems, and, for example, to methods and apparatus for removing gas during thermal runaway in energy storage systems.

### Description of the Related Art

Energy storage systems configured for use with energy management systems are known. Energy storage systems can comprise one or more battery modules (e.g., battery cell packs) that can comprise one or more battery cells (e.g., lithium-ion cells). The one or more battery cell packs are housed in a battery enclosure for protecting the one or more battery cell packs from the environment. In some instances, the one or more battery cells can overheat and cause thermal runaway to occur (e.g., an increase in temperature changes the conditions in a way that causes a further increase in temperature, often leading to a destructive result). For example, during thermal runaway, a battery cell can vent hot, flammable gases which need to be safely dissipated. If the gas escape routes are not intelligently controlled, however, the trapped gases in the battery enclosure can heat up other battery cells and cause propagation of thermal runaway. In such instances, flammable gas concentration can build up and exceed lower flammability limit (LFL), and mixing of flammable gas with oxygen and exposure to high temperature or an ignition source can cause a fire.

Accordingly, there is a need for improved methods and apparatus for removing gas during thermal runaway in energy storage systems.

### SUMMARY

In accordance with at least some aspects of the present disclosure, there is provided an energy storage system comprising a battery enclosure comprising a battery module. The battery enclosure can be configured to couple to a conduit for coupling to another battery enclosure of the energy storage system such that hot gases are allowed to expand from the battery enclosure to the another battery enclosure via the conduit, or vice versa, during thermal runaway.

In accordance with at least some aspects of the present disclosure, there is provided an energy management system comprising a distributed energy resource configured to operably couple to a structure and an energy storage system configured to operably couple to the distributed energy resource. The energy storage system comprises a battery enclosure comprising a battery module and configured to couple to a conduit for coupling to another battery enclosure of the energy storage system such that hot gases are allowed to expand from the battery enclosure to the another battery enclosure via the conduit, or vice versa, during thermal runaway.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram of an energy management system, in accordance with one or more embodiments of the present disclosure; and

FIG. 2 is a diagram of AC battery systems coupled to each other, in accordance with one or more embodiments of the present disclosure.

### DETAILED DESCRIPTION

Embodiments of the present disclosure relate to improved methods and apparatus for removing gas during thermal runaway in energy storage systems. For example, in some embodiments, an energy storage system can comprise a battery enclosure comprising a battery module. The battery enclosure can be configured to couple to a conduit for coupling to another battery enclosure of the energy storage system such that hot gases are allowed to expand from the battery enclosure to the another battery enclosure via the conduit, or vice versa, during thermal runaway. When compared to conventional methods and apparatus, the methods and apparatus described herein provide little to no oxygen ingress into a battery enclosure, provide maximal heat dissipation, and provide a well-defined and repeatable flow pathway for vented gases.

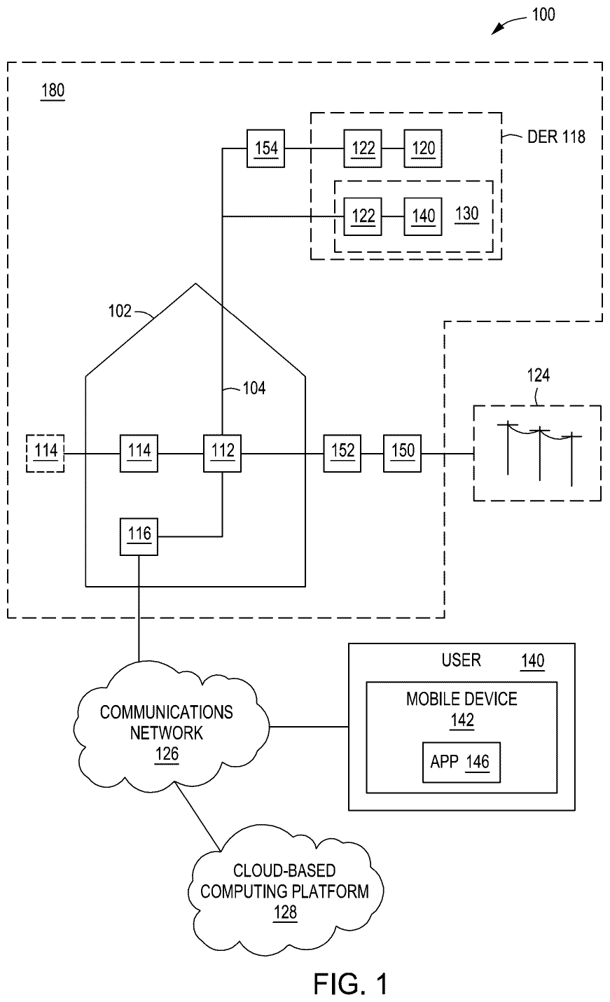

FIG. 1 is a block diagram of a system 100 (e.g., an energy management system or power conversion system) in accordance with one or more embodiments of the present disclosure. The diagram of FIG. 1 only portrays one variation of the myriad of possible system configurations. The present disclosure can function in a variety of environments and systems.

The system 100 comprises a structure 102 (e.g., a user's structure), such as a residential home or commercial building, having an associated DER 118 (distributed energy resource). The DER 118 is situated external to the structure 102. For example, the DER 118 may be located on the roof of the structure 102 or can be part of a solar farm. The structure 102 comprises one or more loads (e.g., appliances, electric hot water heaters, thermostats/detectors, boilers, water pumps, and the like), one or more energy storage devices (an energy storage system 114), which can be located within or outside the structure 102, and a DER controller 116, each coupled to a load center 112. Although the energy storage system 114, the DER controller 116, and the load center 112 are depicted as being located within the structure 102, one or more of these may be located external to the structure 102. In at least some embodiments, the energy storage system 114 can be, for example, one or more of the energy storage devices (e.g., IQ Battery 10®) commercially available from Enphase® Inc. of Petaluma, CA. Other energy storage devices from Enphase® Inc. or other manufacturers may also benefit from the inventive methods and apparatus disclosed herein.

The load center 112 is coupled to the DER 118 by an AC bus 104 and is further coupled, via a meter 152 and a MID 150 (e.g., microgrid interconnect device), to a grid 124 (e.g., a commercial/utility power grid). The structure 102, the energy storage system 114, DER controller 116, DER 118, load center 112, generation meter 154, meter 152, and MID 150 are part of a microgrid 180. It should be noted that one or more additional devices not shown in FIG. 1 may be part of the microgrid 180. For example, a power meter or similar device may be coupled to the load center 112.

The DER 118 comprises at least one renewable energy source (RES) coupled to power conditioners 122 (power conditioner unit). For example, the DER 118 may comprise a plurality of RESs 120 coupled to a plurality of power conditioners 122 in a one-to-one correspondence (or two-to-one). In embodiments described herein, each RES of the plurality of RESs 120 is a photovoltaic module (PV module), although in other embodiments the plurality of RESs 120 may be any type of system for generating DC power from a renewable form of energy, such as wind, hydro, and the like. The DER 118 may further comprise one or more batteries (or other types of energy storage/delivery devices) coupled to the power conditioners 122 in a one-to-one correspondence, where each pair of power conditioner 122 (and a battery management unit (BMU)) and a DC battery 141 (e.g., a battery cell pack) may be referred to as an AC battery 130. The AC battery 130 can be housed in one or more suitable enclosures, as described below.

The power conditioners 122 invert the generated DC power from the plurality of RESs 120 and/or the DC battery 141 to AC power that is grid-compliant and couple the generated AC power to the grid 124 via the load center 112. The generated AC power may be additionally or alternatively coupled via the load center 112 to the one or more loads and/or the energy storage system 114. In addition, the power conditioners 122 that are coupled to the batteries convert AC power from the AC bus 104 to DC power for charging the batteries. A generation meter 154 is coupled at the output of the power conditioners 122 that are coupled to the plurality of RESs 120 in order to measure generated power.

In some alternative embodiments, the power conditioners 122 may be AC-AC converters that receive AC input and convert one type of AC power to another type of AC power. In other alternative embodiments, the power conditioners 122 may be DC-DC converters that convert one type of DC power to another type of DC power. In some of embodiments, the DC-DC converters may be coupled to a main DC-AC inverter for inverting the generated DC output to an AC output.

The power conditioners 122 may communicate with one another and with the DER controller 116 using power line communication (PLC), although additionally and/or alternatively other types of wired and/or wireless communication may be used. The DER controller 116 may provide operative control of the DER 118 and/or receive data or information from the DER 118. For example, the DER controller 116 may be a gateway that receives data (e.g., alarms, messages, operating data, performance data, and the like) from the power conditioners 122. The DER controller 116 can communicate the data and/or other information via the communications network 126 to a cloud-based computing platform 128, which can be configured to execute one or more application software, e.g., a grid connectivity control application, to a remote device or system such as a master controller (not shown), and the like. The DER controller 116 may also send control signals to the power conditioners 122, such as control signals generated by the DER controller 116 or received from a remote device or the cloud-based computing platform 128. The DER controller 116 may be communicably coupled to the communications network 126 via wired and/or wireless techniques. For example, the DER controller 116 may be wirelessly coupled to the communications network 126 via a commercially available router. In one or more embodiments, the DER controller 116 comprises an application-specific integrated circuit (ASIC) or microprocessor along with suitable software (e.g., a grid connectivity control application) for performing one or more of the functions described herein. For example, the DER controller 116 can include a memory (e.g., a non-transitory computer readable storage medium) having stored thereon instructions.

The generation meter 154 (which may also be referred to as a production meter) may be any suitable energy meter that measures the energy generated by the DER 118 (e.g., by the power conditioners 122 coupled to the plurality of RESs 120). The generation meter 154 measures real power flow (kWh) and, in some embodiments, reactive power flow (KVAR). The generation meter 154 may communicate the measured values to the DER controller 116, for example using PLC, other types of wired communications, or wireless communication. Additionally, battery charge/discharge values are received through other networking protocols from the AC battery 130.

The meter 152 may be any suitable energy meter that measures the energy consumed by the microgrid 180, such as a net-metering meter, a bi-directional meter that measures energy imported from the grid 124 and well as energy exported to the grid 124, a dual meter comprising two separate meters for measuring energy ingress and egress, and the like. In some embodiments, the meter 152 comprises the MID 150 or a portion thereof. The meter 152 measures one or more of real power flow (kWh), reactive power flow (KVAR), grid frequency, and grid voltage.

The MID 150, which may also be referred to as an island interconnect device (IID), connects/disconnects the microgrid 180 to/from the grid 124. The MID 150 comprises a disconnect component (e.g., a contactor or the like) for physically connecting/disconnecting the microgrid 180 to/from the grid 124. For example, the DER controller 116 receives information regarding the present state of the system from the power conditioners 122. The DER controller 116 also receives the energy consumption values of the microgrid 180 from the meter 152 (for example via one or more of PLC, other types of wired communication, and wireless communication. Based on the received information (inputs), the DER controller 116 determines when to go on-grid or off-grid and instructs the MID 150 accordingly. In some alternative embodiments, the MID 150 comprises an ASIC or CPU, along with suitable software (e.g., an islanding module), for determining when to disconnect from/connect to the grid 124. For example, the MID 150 may monitor the grid 124 and detect a grid fluctuation, disturbance or outage and, as a result, disconnect the microgrid 180 from the grid 124. Once disconnected from the grid 124, the microgrid 180 can continue to generate power as an intentional island without imposing safety risks, for example on any line workers that may be working on the grid 124.

In some alternative embodiments, the MID 150 or a portion of the MID 150 is part of the DER controller 116. For example, the DER controller 116 may comprise a CPU and an islanding module for monitoring the grid 124, detecting grid failures and disturbances, determining when to disconnect from/connect to the grid 124, and driving a disconnect component accordingly. The disconnect component may be part of the DER controller 116 or, alternatively, separate from the DER controller 116. In some embodiments, the MID 150 may communicate with the DER controller 116 (e.g., using wired techniques such as power line communications, or using wireless communication) for coordinating connection/disconnection to the grid 124.

A user 140 can use one or more computing devices, such as a mobile device 142 (e.g., a smart phone, tablet, or the like) communicably coupled by wireless means to the communications network 126. The mobile device 142 has a CPU, support circuits, and memory, and has one or more applications 146 (e.g., a grid connectivity control application) installed thereon for controlling the connectivity with the grid 124 as described herein. The one or more applications 146 may run on commercially available operating systems, such as IOS, ANDROID, and the like.

In order to control connectivity with the grid 124, the user 140 interacts with an icon displayed on the mobile device 142, for example a grid on-off toggle control or slide, which is referred to herein as a toggle button. The toggle button may be presented on one or more status screens pertaining to the microgrid 180, such as a live status screen (not shown), for various validations, checks and alerts. The first time the user 140 interacts with the toggle button, the user 140 is taken to a consent page, such as a grid connectivity consent page, under setting and will be allowed to interact with toggle button only after he/she gives consent. Based on the desired action as entered by the user 140, the corresponding instructions are communicated to the DER controller 116 via the communications network 126 using any suitable protocol, such as HTTP(S), MQTT(S), WebSockets, and the like. The DER controller 116, which may store the received instructions as needed, instructs the MID 150 to connect to or disconnect from the grid 124 as appropriate.

The inventive concepts described herein allow gases to be shared between multiple AC battery systems (e.g., a battery module+BMU+PCU (stack)+enclosure). For example, in some embodiments, there can be three (3) (sometimes more) AC batteries connected by conduits. For illustrative purposes, two (2) AC battery systems are shown.

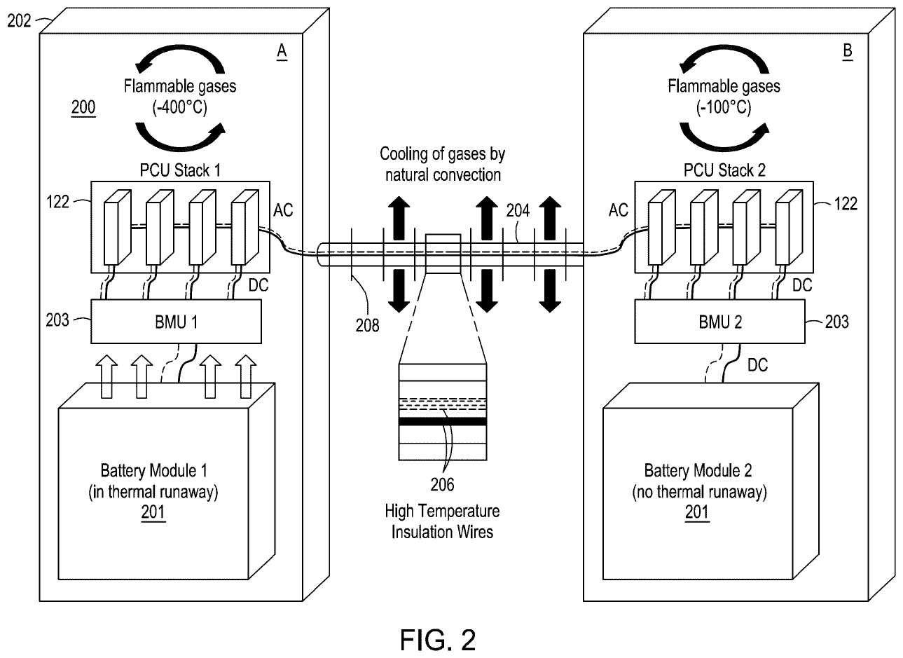

For example, FIG. 2 is a diagram of AC battery systems 200 (e.g., energy storage system) coupled to each other, in accordance with one or more embodiments of the present disclosure. The AC battery systems 200 are configured for use with the system 100. For example, as noted above, an AC battery system (e.g., the AC battery 130) can comprise battery modules 201 (e.g., the DC battery 141), power conditioners (e.g., the power conditioners 122), and a BMU 203 and can be housed in a battery enclosure 202, which can be made from any suitable material capable of housing the components of the AC battery system 200, e.g., plastic, metal, ceramic, etc.).

FIG. 2 illustrates two battery enclosures 202 that are coupled to each other via a conduit 204, which can be made from the same material as the battery enclosure 202 or a different material from the battery enclosure 202. In at least some embodiments, the two battery enclosures 202 and the conduit 204 are made from metal. The two battery enclosures 202 are fully enclosed (contained) except for the conduit 204, thus preventing oxygen ingress and from oxygen mixing with flammable gas during thermal runaway. In at least some embodiments, wiring 206 disposed in the conduit 204 can be surrounded/covered by high temperature insulation, shielding and/or tubing. The high temperature insulation, shielding and/or tubing is impervious to hot gases that may be present in the conduit 204 and, thus, prevents shorting from occurring between the wires of the wiring 206 (e.g., due to melted insulation), which, in turn, eliminates the risk of creating sparks that can ultimately lead to ignition of the hot gases.

In a thermal runaway event, the conduit 204 allows the hot gases (flammable gases at about 400° C., greater or less) to be vented to adjacent battery enclosures. For example, hot gases can flow from the battery enclosure A through the conduit 204 (or conduits depending on how many battery enclosures are connected to each other) and to the battery enclosure B (or vice versa) to allow the hot gases to expand, thus keeping overall pressure low within the battery enclosure and lowering a temperature of the hot gases (e.g., to about 100° C. greater or less). Additionally, as a battery module has a relatively large thermal mass, the battery module is capable of absorbing heat from the hot gases, e.g., even spreading of heat across the one or more battery cells prevents any of the one or more battery cells from reaching onset temperature for thermal runaway.

Additionally, the conduit 204 is also configured to provide cooling of the hot gases via a natural convection process. Accordingly, in at least some embodiments, the conduit 204 can be made from one or more metals that are suitable for providing/facilitating natural convection, such copper and/or aluminum. Additionally, in at least some embodiments, one or more cooling fins 208 can be provided along an exterior of the conduit 204 to facilitate the natural convection process.

While the foregoing is directed to embodiments of the present disclosure, other and further embodiments of the disclosure may be devised without departing from the basic scope thereof, and the scope thereof is determined by the claims that follow.

What is claimed is:

1. An energy storage system, comprising:
a battery enclosure comprising a battery module and configured to couple to a conduit for coupling to another battery enclosure of the energy storage system such that hot gases are allowed to expand from the battery enclosure to the another battery enclosure via the conduit, or vice versa, during thermal runaway.

2. The energy storage system of claim 1, further comprising wiring that is surrounded/covered by high temperature insulation, shielding and/or tubing, which is impervious to the hot gases present in the conduit.

3. The energy storage system of claim 1, wherein the battery enclosure is fully enclosed to prevent oxygen ingress and oxygen from mixing with the hot gases.

4. The energy storage system of claim 1, wherein the conduit is made from a metal that facilitates natural convection for cooling the hot gases in the conduit.

5. The energy storage system of claim 4, wherein the conduit is made from at least one of copper or aluminum.

6. The energy storage system of claim 1, wherein the conduit comprises a fin that is disposed along an exterior of the conduit and configured to facilitate natural convection for cooling the hot gases in the conduit.

7. The energy storage system of claim 1, further comprising a DC battery.

8. The energy storage system of claim 1, further comprising a battery management unit.

9. The energy storage system of claim 1, further comprising a power conditioner unit.

10. The energy storage system of claim 1, wherein the hot gases are flammable gases at about 400° C.

11. The energy storage system of claim 1, wherein the battery enclosure and the another battery enclosure are made from one of plastic, metal, or ceramic.

12. The energy storage system of claim 1, wherein the battery module has a relatively large thermal mass that is capable of absorbing heat from the hot gases such that the heat is spread evenly across one or more battery cells of the battery module to prevent any of the one or more battery cells from reaching onset temperature for thermal runaway.

13. An energy management system comprising:
a distributed energy resource configured to operably couple to a structure; and
an energy storage system configured to operably couple to the distributed energy resource and comprising:
a battery enclosure comprising a battery module and configured to couple to a conduit for coupling to another battery enclosure of the energy storage system such that hot gases are allowed to expand from the battery enclosure to the another battery enclosure via the conduit, or vice versa, during thermal runaway.

14. The energy management system of claim 13, further comprising wiring that is surrounded/covered by high temperature insulation, shielding and/or tubing, which is impervious to the hot gases present in the conduit.

15. The energy management system of claim 13, wherein the battery enclosure is fully enclosed to prevent oxygen ingress and oxygen from mixing with the hot gases.

16. The energy management system of claim 13, wherein the conduit is made from a metal that facilitates natural convection for cooling the hot gases in the conduit.

17. The energy management system of claim 16, wherein the conduit is made from at least one of copper or aluminum.

18. The energy management system of claim 13, wherein the conduit comprises a fin that is disposed along an exterior of the conduit and configured to facilitate natural convection for cooling the hot gases in the conduit.

19. The energy management system of claim 13, further comprising a DC battery.

20. The energy management system of claim 13, further comprising a battery management unit.
